(19) United States
(12) Patent Application Publication
(10) Pub. No.: US 2005/0123039 A1
(43) Pub. Date: Jun. 9, 2005

(54) Motion estimation method for motion picture encoding and recording medium having program recorded thereon to implement the motion estimation method

(75) Inventors: Byung-cheol Song, Suwon-si (KR); Kang-wook Chun, Hwassono-gun (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/994,435

(22) Filed: Nov. 23, 2004

(30) Foreign Application Priority Data
Dec. 6, 2003 (KR) 2003-88779

(51) Int. Cl. H04B 1/66

(52) U.S. Cl. 375/240.11

(57) ABSTRACT

A motion estimation method in a hierarchical frame structure, applied to motion picture encoding, the method including, calculating, an initial motion vector of a predetermined block of a current frame at a low resolution with reference to an adjacent frame of the current frame, calculating a reference motion vector using the calculated initial motion vector for motion estimation between the current frame and a reference frame, adjusting a resolution of the calculated reference motion vector to a high resolution, determining a search area within the reference frame based on the adjusted reference motion vector and calculating a final motion vector by performing motion estimation within the determined search area.

### CROSS-REFERENCE TO RELATED APPLICATION

This application claims the priority of Korean Patent Application No. 2003-88779, filed on Dec. 8, 2003 in the Korean Intellectual Property Office, the disclosure of which is incorporated herein by reference.

### BACKGROUND OF THE INVENTION

1. Field of the Invention

The present invention relates to motion picture encoding, and more particularly, to a motion estimation method in a hierarchical frame structure in which a motion vector is calculated based on a reference candidate motion vector that is calculated at each hierarchical frame level.

2. Description of the Related Art

In general, a part that requires the largest amount of computation in a motion picture encoder is a motion estimation unit. Fast motion estimation algorithms are intended to reduce the amount of computation of such a motion estimation unit. Fast motion estimation algorithms perform faster computation than full search block matching algorithms without performance degradation. Full search block matching algorithms divide a current frame and a reference frame into blocks having a predetermined size, search for the location of the best-matching block by comparing each block of the current frame with every block included in a search area of the reference frame according to given matching standards, and estimate a two-dimensional motion vector for each block. The sum of absolute difference (SAD) is one type of reference information used in such block matching.

Among fast motion estimation algorithms, hierarchical, multi-resolution search algorithms have been preferred. An example of such hierarchical, multi-resolution search algorithms is disclosed in Korean Patent No. 10-275694 titled “High-speed motion vector estimation for real-time based motion picture encoding”.

FIG. 1 is a view explaining a hierarchical frame structure used in hierarchical motion vector searching.

At level 0, one macroblock is composed of 16×16 pixels. At level 1, one macroblock is composed of 8×8 pixels and level 1 is obtained by averaging adjacent 2×2 pixels at level 0. At level 2, one macroblock is composed of 4×4 pixels and level 2 is obtained by averaging adjacent 2×2 pixels at level 1. Although the hierarchical frame structure has three levels in FIG. 1, a frame structure having two levels or more than 3 levels may be used.

FIG. 2 is a view for explaining general hierarchical motion vector searching.

Referring to FIG. 2, general hierarchical motion vector searching includes searching at a lowest-resolution level (level 2), searching at an intermediate resolution level (level 1), and searching at a highest-resolution level (level 0).

General hierarchical motion estimation includes:
(i) performing a full search at the lowest-resolution level and determining search points having the minimum SAD obtained through the full search to be initial search points of the intermediate resolution level (operation 220);
(ii) performing local searching in a narrow area surrounding the determined search points, and determining search points having the minimum SAD to be initial search points of the highest-resolution level (operation 240); and
(iii) selecting a final motion vector by performing local searching in a narrow area surrounding the determined search points at the highest-resolution level (operation 260).

FIG. 3 is a view for explaining hierarchical searching in an MPEG-2 encoder to which general hierarchical motion estimation described with reference to FIG. 2.

As shown in FIG. 3, according to MPEG-2, in the case of P frames, hierarchical searching should be performed five times in frames and fields. In other words, inter-frame motion estimation (Frame ME), inter-top field motion estimation (Top2Top), motion estimation between a top field and a bottom field (Top2Bot), motion estimation between a bottom field and a top field (Bot2Top), and inter-bottom field motion estimation (Bot2Bot) should be performed. Also, in the case of B frames, since such hierarchical searching should be performed both in forward directions and backward directions, it may be performed ten times.

Accordingly, motion estimation of MPEG-2 motion picture encoders requires frame motion estimation and field motion estimation, and moreover, hierarchical searching should be performed both in forward directions and backward directions in the case of B frames. As a result, if hierarchical searching is applied to MPEG-2 motion estimation, a memory for frame motion estimation and a memory for field motion estimation are separately required and a vast amount of computation is required for motion estimation.

### SUMMARY OF THE INVENTION

According to an aspect of the present invention there is provided a motion estimation method by which motion estimation is performed on a reference frame by using a reference motion vector calculated at a low resolution with reference to an adjacent frame, so as to reduce the amount of computation and memory required for motion estimation, and a computer readable recording medium having a program recorded thereon to implement the motion estimation method.

According to one aspect of the present invention, there is provided a motion estimation method for encoding motion pictures. The motion estimation method includes calculating an initial motion vector of a predetermined block of a current frame at a low resolution with reference to an adjacent frame of the current frame, calculating a reference motion vector with reference to the calculated initial motion vector for motion estimation between the current frame and a reference frame, and adjusting a resolution of the reference motion vector to correspond to a high resolution, determining a search area within the reference frame at the high resolution based on the adjusted reference motion vector, and calculating a final motion vector by performing motion estimation within the determined search area.

According to another aspect of the present invention, there is provided a computer readable recording medium having recorded thereon a program for a motion estimation method for encoding motion pictures. The motion estimation method includes calculating an initial motion vector of a predetermined block of a current frame at a low resolution with reference to an adjacent frame of the current frame, calculating a reference motion vector with reference to the calculated initial motion vector for motion estimation between the current frame and a reference frame, and adjusting a resolution of the reference motion vector to correspond to a high resolution, determining a search area within the reference frame at the high resolution based on the adjusted reference motion vector, and calculating a final motion vector by performing motion estimation within the determined search area.

According to still another aspect of the present invention, there is provided a motion estimation method for encoding motion pictures. The motion estimation method includes calculating an initial motion vector of a predetermined block of a current frame at a low resolution with reference to an adjacent frame of the current frame, calculating a reference motion vector based on the calculated initial motion vector for motion estimation between the current frame and a reference frame, determining a first search area in the reference frame based on the reference motion vector and calculating a candidate motion vector by performing motion vector estimation within the determined first search area at the low resolution, and adjusting a resolution of the candidate motion vector to correspond to a high resolution, determining a second search area based on the adjusted candidate motion vector, and calculating a final motion vector by performing motion estimation within the determined second search area at the high resolution.

According to yet another aspect of the present invention, there is provided a computer readable recording medium having recorded thereon a program for a motion estimation method for encoding motion pictures. The motion estimation method includes calculating an initial motion vector of a predetermined block of a current frame at a low resolution with reference to an adjacent frame of the current frame, calculating a reference motion vector based on the calculated initial motion vector for motion estimation between the current frame and a reference frame, determining a first search area in the reference frame based on the reference motion vector and calculating a candidate motion vector by performing motion vector estimation within the determined first search area at the low resolution, and adjusting a resolution of the candidate motion vector to correspond to a high resolution, determining a second search area based on the adjusted candidate motion vector, and calculating a final motion vector by performing motion estimation within the determined second search area at the high resolution.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become more apparent and readily appreciated from the following description of the embodiments, taken in conjunction with the accompanying drawings of which:

FIG. 1 is a view for explaining a hierarchical frame structure used in hierarchical motion vector searching;

FIG. 2 is a view for explaining general hierarchical motion vector searching;

FIG. 3 is a view for explaining hierarchical searching in an MPEG-2 encoder;

FIG. 4 is a block diagram of a motion picture encoding system according to an aspect of the present invention;

FIG. 5 is a view for explaining a hierarchical motion estimation method according to an aspect of the present invention;

FIG. 6 shows resolutions of macroblocks at levels, which are used in an embodiment of the present invention;

FIG. 7 shows an example in which an embodiment of the present invention is applied to an IBBP frame structure;

FIG. 8 shows an example in which another embodiment of the present invention is applied to the IBBP frame structure;

FIG. 9 shows an example in which yet another embodiment of the present invention is applied to the IBBP frame structure;

FIG. 10 shows motion vectors of adjacent macroblocks used in motion estimation at level 1;

FIG. 11 is a flowchart illustrating a hierarchical motion vector estimation method according to an embodiment of the present invention; and

FIG. 12 is a flowchart illustrating a hierarchical motion vector estimation method according to another embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

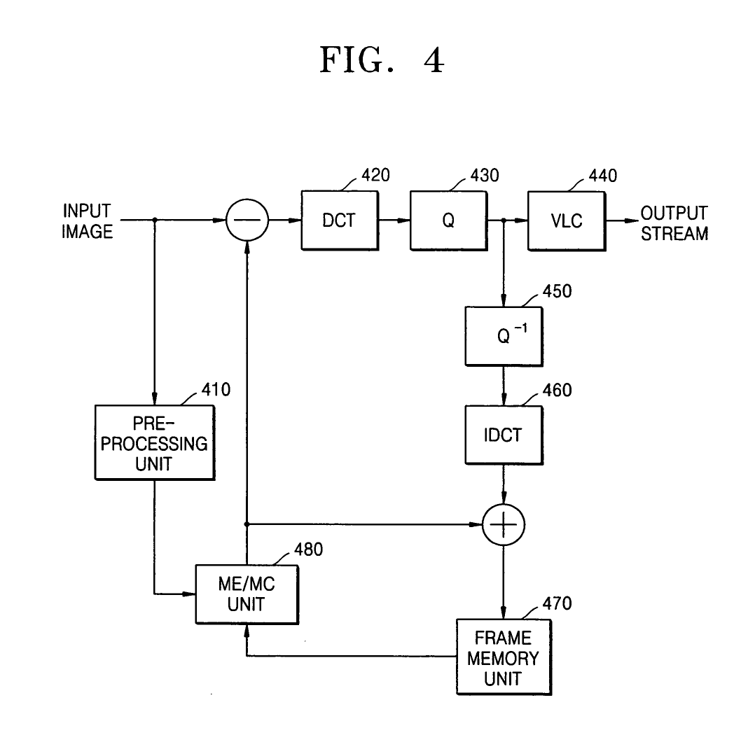

FIG. 4 is a block diagram of a motion picture encoding system according to an aspect of the present invention.

Input image data is made up of group of picture (GOP) units. A discrete cosine transform (DCT) unit 420 performs DCT on an 8×8 block-by-block basis to obtain spatial redundancy of the input image data. A quantization (Q) unit 430 quantizes the image data that is discrete cosine transformed by the DCT unit 420. A dequantization (Q−1) unit 450 dequantizes the image data that is quantized by the quantization unit 430. An inverse DCT (IDCT) unit 460 performs IDCT on the image data that is dequantized by the dequantization unit 450. A frame memory unit 470 stores the image data that is inverse discrete cosine transformed by the IDCT unit 460 on a frame-by-frame basis. A motion estimation (ME)/motion compensation (MC) unit 480 estimates a motion vector (MV) and an SAD for each macroblock using image data of a current input frame and image data of a previous frame stored in the frame memory unit 470. A variable length-coding (VLC) unit 440 removes statistical redundancy of the quantized image data according to the motion vector estimated by the ME/MC unit 480.

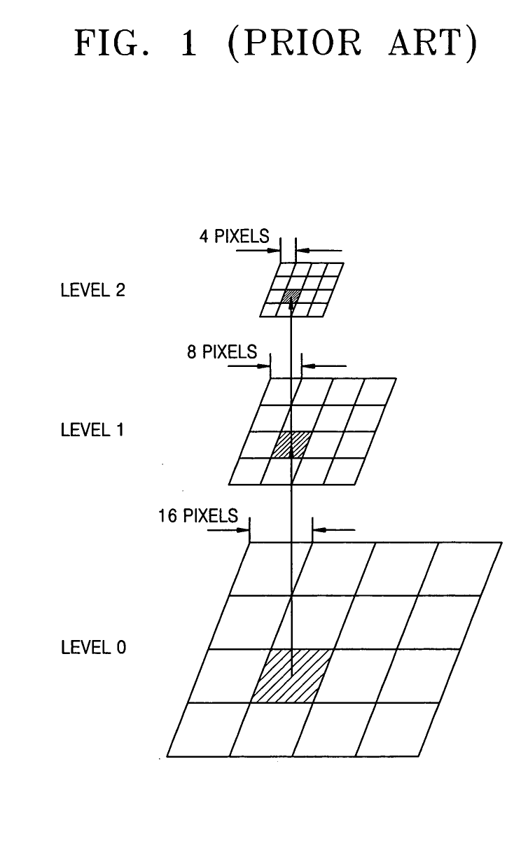

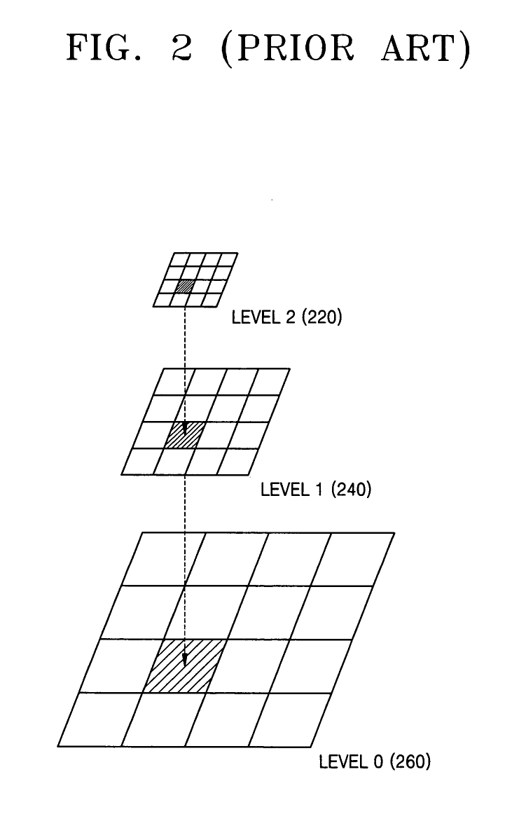

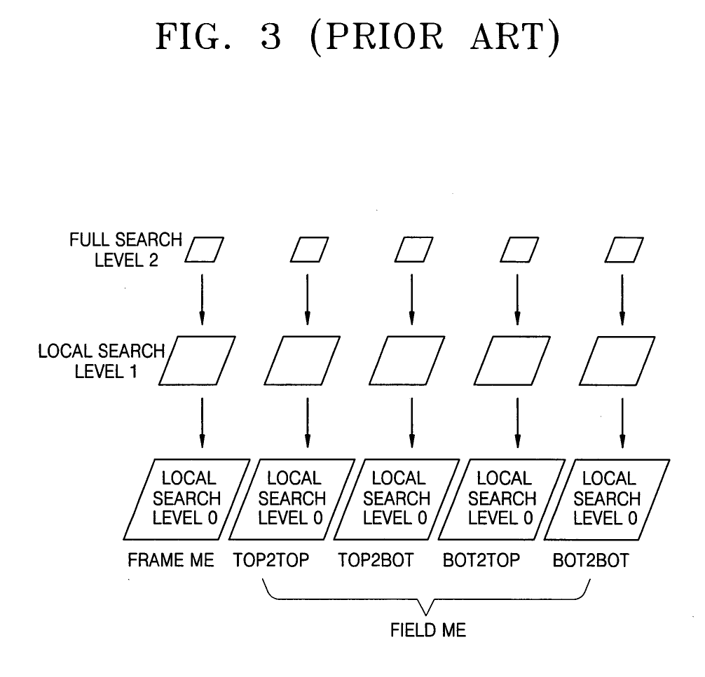

Referring to FIGS. 1 and 2, to perform hierarchical motion estimation, both the current frame and the reference frame should have a resolution structure processed through low-resolution filtering and sub sampling. Therefore, a pre-processing unit 410 pre-processes the current frame and the reference frame to low-resolution frames through sub sampling.

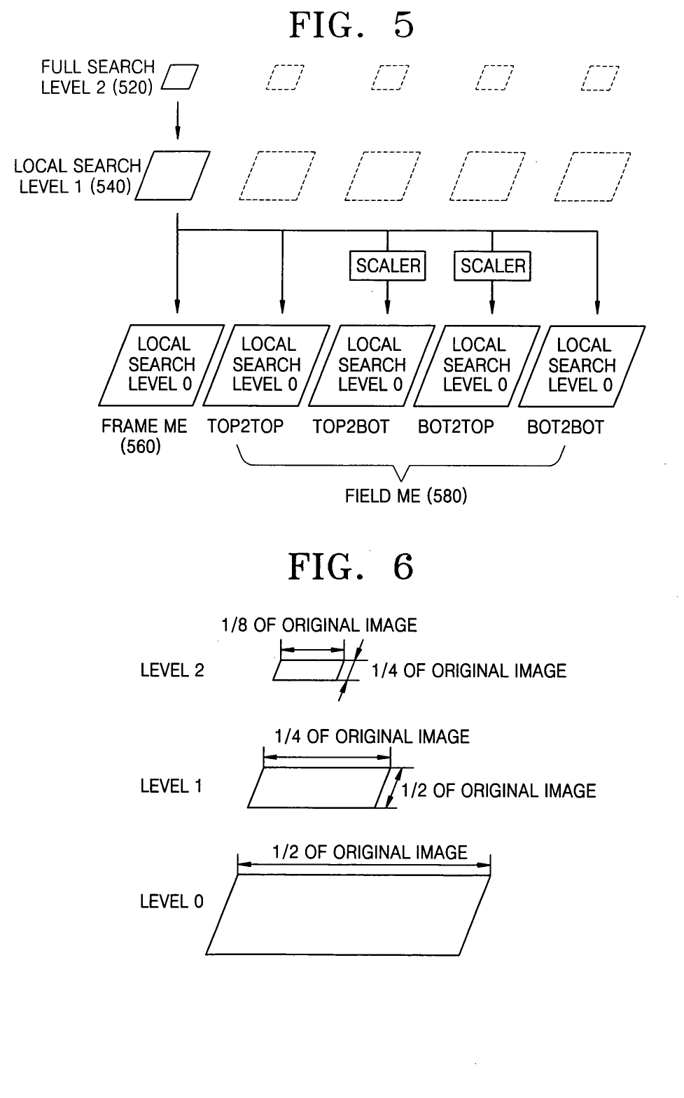

FIG. 5 is a view explaining a hierarchical motion estimation method according to an aspect of the present invention.

The current frame and the reference frame are formed into hierarchical structures through low-pass filtering and sub sampling.

At least one initial search point (vector) having a minimum SAD is searched by performing a full search at a lowest-resolution level (level 2) for motion estimation on a frame-by-frame basis (520).

A motion vector having a minimum SAD on a frame-by-frame basis is obtained by performing local searches for motion estimation on a frame-by-frame basis at an intermediate resolution level (level 1) using the found initial motion vectors of the lowest-resolution level (level 2) (520). At this time, the motion vector obtained at the intermediate-resolution level (level 1) is referred to as a based motion vector.

The based motion vector of the intermediate-resolution level (level 1) is commonly applied to frame motion estimation and field motion estimation at a highest-resolution level (level 0) (560). In other words, after local searches for motion estimation on a frame-by-frame basis and local searches for motion estimation on a field-by-field basis are performed using the based motion vector of the intermediate-resolution level (level 1) at the highest-resolution level (level 0), the motion vector having the minimum SAD on a frame-by-frame basis and the motion vector having the minimum SAD on a field-by-field basis are simultaneously estimated. At this time, a motion vector with respect to motion estimation between a top field and a top field (Top2Top) and with respect to motion estimation between a bottom field and a bottom field (Bot2Bot) are estimated with reference to SAD for each field which is automatically obtained in motion estimation. The based motion vector cannot be applied to the motion estimation between a top field and a bottom field (Top2Bot) and motion estimation between a bottom field and a top field (Bot2Top) because the distances between fields are different. Thus, the motion estimation between a top field and a bottom field (Top2Bot) and the motion estimation between a bottom field and a top field (Bot2Top) by selecting motion vectors having the minimum SAD between the top field and the bottom field (Top2Bot) and between the bottom field and the top field (Bot2Top) after performing local searches based on a based motion vector that is scaled, is based on the distance between fields.

As such, field motion estimation does not perform searches at the lowest-resolution level (level 2) and the intermediate-resolution level (level 1). Instead, local searches on a narrow search area are performed at the highest-resolution level (level 0) using search points obtained through frame motion estimation at the intermediate-resolution level (level 1).

FIG. 6 shows resolutions of macroblocks at levels, which are used in an embodiment of the present invention.

In this embodiment, it is assumed that motion estimation is performed in a frame structure having three-level resolutions. However, it is natural that motion estimation be performed in a frame structure having resolutions of more than 3 levels. In the present invention, resolutions in the horizontal direction at levels 1, 2, and 3 are half resolutions of the vertical direction as shown in FIG. 6. In other words, since correlation between pixels in the horizontal direction is higher than that in the vertical direction, even though sub sampling is performed in the horizontal direction more number of times than in the vertical direction, there is little impact on the performance. Thus, the size of a macroblock at level 2 is ¼ of an original image (level 0) in the vertical direction and ⅛ of the original image (level 0) in the horizontal direction. Also, the size of a macroblock at level 1 is ½ of the original image (level 0) in the vertical direction and ¼ of the original image (level 0) in the horizontal direction.

The size of a macroblock at level 0 is equal to the original image (level 0) in the vertical direction and ½ of the original image (level 0) in the horizontal direction. Such a frame structure can be created by performing filtering on the original image in the vertical and horizontal directions using low-pass filtering (LPF) having the proper number of taps. For example, LPF may be {1, 2, 1}/4. Alternatively, another type of LPF may be used. Also, only sub sampling may be performed without performing LPF.

Here, LPF is performed. Proper 1-D LPF is applied to an image at level 0 only in the horizontal direction and is then 2:1 sub sampled to obtain the image at level 0 as shown in FIG. 6. Proper 1-D LPF is applied to the image at level 0 in the horizontal direction and is then 2:1 sub sampled, and proper 1-D LPF is applied to the image at level 0 in the vertical direction and is then 2:1 sub sampled. Thus, an image at level 1 as shown in FIG. 6 is created. Proper 1-D LPF is applied to the image at level 1 in the horizontal direction and is then 2:1 sub sampled, and proper 1-D LPF is applied to the image at level 1 in the vertical direction and is then 2:1 sub sampled. Thus, an image at level 2 as shown in FIG. 6 is created.

Therefore, the size of the macroblock at level 0 is 8×16, the size of the macroblock at level 1 is 4×8, and the size of the macroblock at level 2 is 2×4.

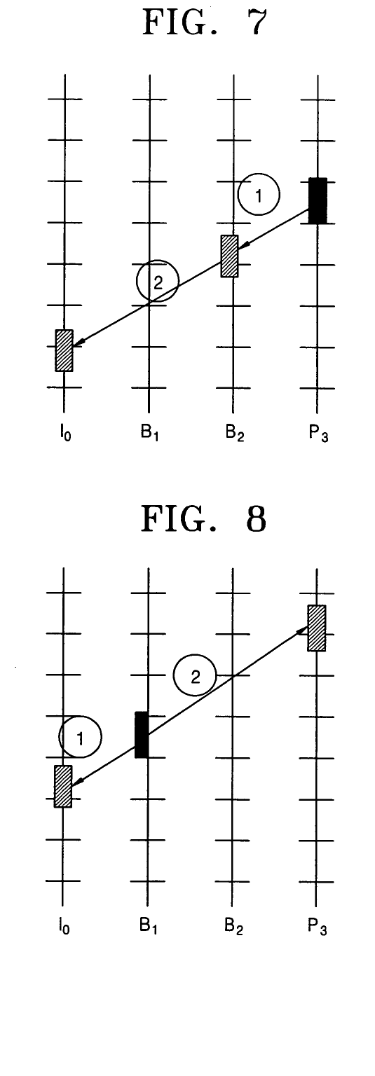

FIG. 7 shows an example in which a hierarchical motion estimation method according to an embodiment of the present invention is applied to an IBBP frame structure.

In FIG. 7, motion estimation with respect to a macroblock including a current frame, i.e., P₃, is shown. First, an initial motion vector 1 is calculated by performing motion estimation with reference to a frame B₂ that is adjacent to the current frame P₃. At this time, the frame B₂ is referred to obtain the initial motion vector 1 that is used to calculate a reference motion vector 2 between the current frame P₃ and a reference frame I₀ for motion estimation of a current macroblock. Thus, it is not necessary to perform motion estimation at every level for the purpose of calculating the initial motion vector 1.

In this embodiment, motion estimation is only performed at level 2 and 1, and motion estimation at level 0 and half-pixel accuracy motion estimation are not performed. Alternatively, motion estimation may be only performed at level 1 and motion estimation at level 0 and half-pixel accuracy motion estimation may be omitted.

If a result of first motion estimation of the current macroblock, which is obtained with reference to the adjacent frame B₂, i.e., the initial motion vector 1, is MV_{L1}, an initial point for final motion estimation that refers to the reference frame I₀ is calculated based on the initial motion vector 1. The initial point is determined by the reference motion vector 2 that is an extension of the initial motion vector 1 to fit the distance between the current frame P₃ and the reference frame I₀.

In the case of FIG. 7, the initial point of the reference frame I₀ for motion estimation is determined by 3*MV_{L1}, i.e., the reference motion vector 2 is an extension of the initial motion vector 1. In this embodiment, a search area is determined based on the determined initial point, motion estimation is performed at level 1 within the determined search area, and motion estimation is performed at level 0 based on a result of motion estimation at level 1.

In this embodiment, the search area is determined based on the initial point determined by the reference motion vector 2, motion estimation is performed at level 1, and then motion estimation is performed at level 0. However, alternatively, the resolution of the reference motion vector 2 is adjusted, the search area is determined based on the adjusted resolution and the initial point determined, for example, at level 0, and motion estimation is performed at the determined search area.

FIG. 8 shows an example in which a hierarchical motion estimation method according to another embodiment of the present invention is applied to the IBBP frame structure.

In FIG. 8, motion estimation of a macroblock included in a current frame, i.e., a frame B1, is shown. First, forward-direction motion estimation is performed with reference to a frame I₀ that is adjacent to the current frame B1. Forward-direction motion estimation is performed at level 2, level 1, and level 0. Half-pixel accuracy motion estimation may be selectively performed.

Backward-direction motion estimation is performed using a motion vector obtained in forward-direction motion estimation as its initial point. In this embodiment, backward-direction motion estimation does not use a motion vector at level 0 of the forward direction motion estimation or a half-pixel accuracy motion vector as its initial point, but is performed based on a motion vector at level 1 of the forward direction motion estimation.

At this time, assuming that the initial motion vector 1 at level 1 of the forward direction is MV_{L1}_{_{—}}_{forward}, the reference motion vector 1 for backward-direction motion estimation is (−2)*MV_{L1}_{_{—}}_{forward} and the initial point of a reference frame P₃ is determined by (−2)*MV_{L1}_{_{—}}_{forward}. Motion estimation based on the determined initial point is performed in the same manner as in FIG. 7.

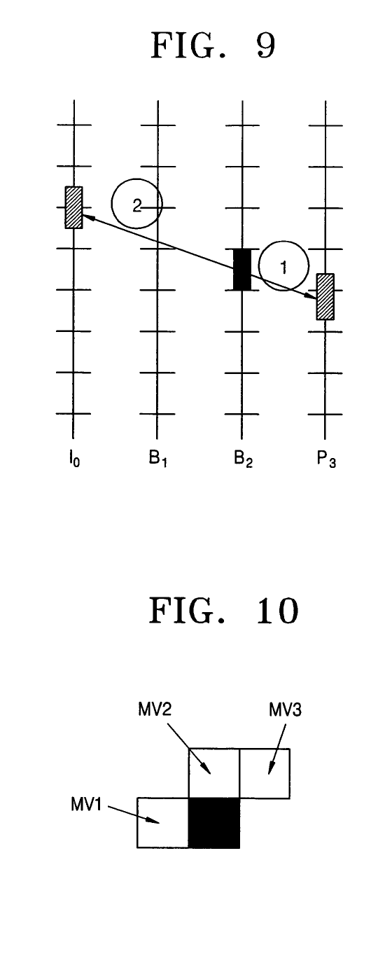

FIG. 9 shows an example in which a hierarchical motion estimation method according to yet another embodiment of the present invention is applied to the IBBP frame structure.

In FIG. 9, motion estimation of a macroblock in which a current frame is included in a second frame, i.e., a frame B2, in the IBBP frame structure. First, reward-direction motion estimation is performed with reference to a frame P3 that is adjacent to a current frame B2. Backward-direction motion estimation is performed at level 2, level 1, and level 0. Half-pixel accuracy motion estimation may be selectively performed.

Forward-direction motion estimation is performed using the motion vector obtained in backward-direction motion estimation as its initial point. In this embodiment, forward-direction motion estimation does not use a motion vector at level 0 of the backward direction motion estimation or a half-pixel accuracy motion vector as its initial point, but is performed based on a motion vector at level 1 of the backward direction motion estimation.

At this time, assuming that the initial motion vector 1 at level 1 of the forward direction is MV_{L1}_{_{—}}_{forward}, the reference motion vector 2 for backward-direction motion estimation is (−2)* MV_{L1}_{_{—}}_{forward} and the initial point of a reference frame P₃ is determined by (−2)*MV_{L1}_{_{—}}_{forward}. Motion estimation based on the determined initial point is performed in the same manner as in FIG. 7.

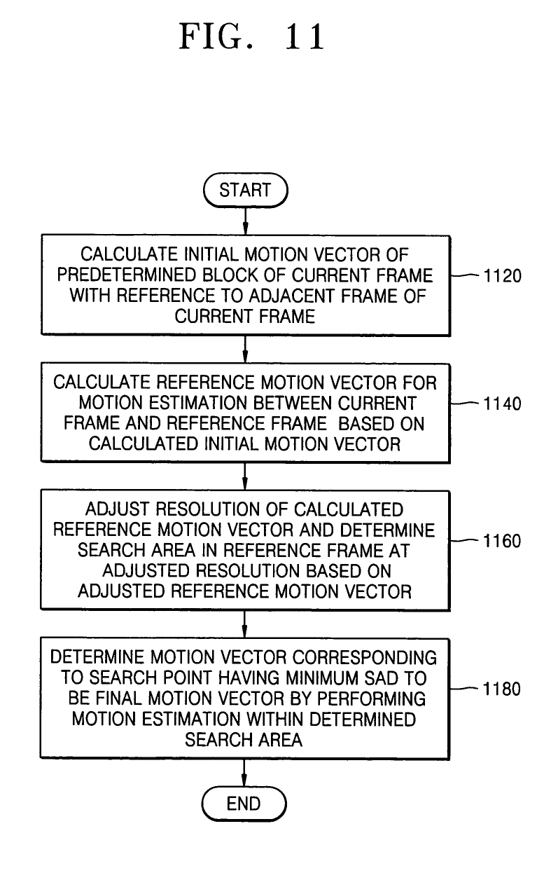

FIG. 10 shows motion vectors of adjacent macroblocks used in motion estimation at level 1.

The motion vectors of adjacent macroblocks used in the present invention are the motion vectors at level 1. Thus, in the case of FIG. 8 or FIG. 9, prior to completion of motion estimation at level 0, the motion vectors obtained in motion estimation at level 1 are used, whereby memory capacity and processing time required to store the motion vectors of adjacent macroblocks can be reduced. In particular, processing time can be significantly reduced in a pipeline structure.

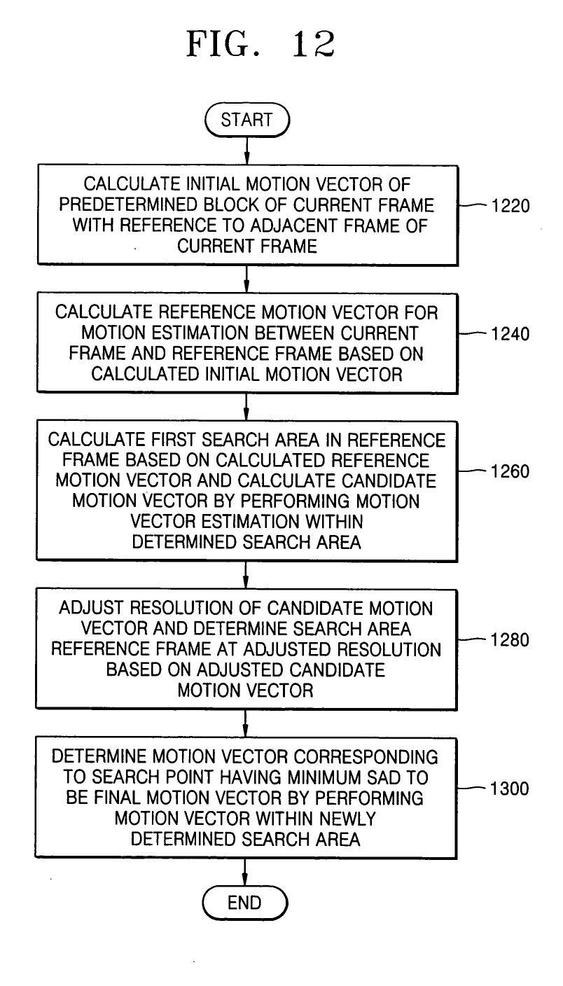

FIG. 11 is a flowchart illustrating a hierarchical motion vector estimation method according to an embodiment of the present invention, where the hierarchical motion vector estimation method corresponds to frame motion estimation 520 and 540 shown in FIG. 5. Hereinafter, the hierarchical motion vector estimation method according to an embodiment of the present invention will be described with reference to FIG. 7.

In operation 1120, an initial motion vector of a predetermined block of a current frame is calculated with reference to an adjacent frame of the current frame. Referring to FIG. 7, the current frame is represented by P3, the adjacent frame is represented by B2, and the initial motion vector is represented by 1.

In this embodiment, the initial motion vector is calculated using hierarchical motion estimation based on the frame structure shown in FIG. 6. In other words, after motion estimation is performed at level 2 of the lowest resolution, a result of motion estimation at level 1 of the intermediate resolution using a result of motion estimation at level 2 is determined to be the initial motion vector. Alternatively, the initial motion vector may be determined at level 1.

Alternatively, shown in FIG. 10, motion vectors of adjacent blocks at level 1 are read, one candidate motion vector is selected using correlation between the adjacent blocks, a search area in an adjacent frame is determined using the selected candidate motion vector, and a result of motion estimation using SAD with respect to the determined search area is used for calculation of the initial motion vector 1. For example, a result of motion estimation obtained using motion vectors of adjacent macroblocks is compared with results of sequential motion estimation at level 2 and level 1, and a motion vector corresponding to a result having the minimum SAD may be determined to be the initial motion vector 1.

At this time, the candidate motion vector can be obtained by taking the medians of x coordinates and y coordinates of motion vectors of adjacent blocks. For example, if the motion vectors of adjacent blocks are (5, 6), (3, 8), and (7, 7), {median (5, 3, 7), median (6, 7, 8)} are equal to (5, 7).

In operation 1140, based on the calculated initial motion vector 1, a reference motion vector (2 of FIG. 7) for motion estimation between the current frame and the reference frame (I₀ of FIG. 7) is calculated. The reference motion vector is obtained based on the initial motion vector and a scaling coefficient based on the distance between frames.

In operation 1160, a resolution of the calculated reference motion vector 2 is adjusted, and a search area in the reference frame is determined at the adjusted resolution based on the adjusted reference motion vector. In this embodiment, the resolution of the calculated reference motion vector is adjusted from level 1 to level 0, and a search area in level 0 is newly determined using the adjusted reference motion vector.

In operation 1180, a motion vector corresponding to a search point having the minimum SAD is determined to be a final motion vector by performing motion estimation within the search area determined in operation 1160.

FIG. 12 is a flowchart illustrating a hierarchical motion vector estimation method according to another embodiment of the present invention. Hereinafter, the hierarchical motion vector estimation method according to another embodiment of the present invention will be described with reference to FIG. 7.

In operation 1220, an initial motion vector of a predetermined block of a current frame is calculated with reference to an adjacent frame of the current frame. The current frame is represented by P3, the adjacent frame is represented by B2, and the initial motion vector is represented by 1.

In this embodiment, the initial motion vector is calculated using hierarchical motion estimation based on the frame structure shown in FIG. 6. In other words, after motion estimation is performed at level 2 of the lowest resolution, a result of motion estimation at level 1 of the intermediate resolution using a result of motion estimation at level 2 is determined to be the initial motion vector. Alternatively, the initial motion vector may be determined at level 1.

Alternatively, shown in FIG. 10, motion vectors of adjacent blocks at level 1 are read, one candidate motion vector is selected using correlation between the adjacent blocks, a search area in an adjacent frame is determined using the selected candidate motion vector, and a result of motion estimation using SAD with respect to the determined search area is used for calculation of the initial motion vector 1.

In operation 1240, based on the calculated initial motion vector 1, a reference motion vector (2 of FIG. 7) for motion estimation between the current frame and the reference frame (I₀ of FIG. 7) is calculated. The reference motion vector is obtained based on the initial motion vector and a scaling coefficient based on the distance between frames.

In operation 1260, a first search area is determined in the reference frame I₀ based on the calculated reference motion vector 2 and a candidate motion vector is calculated by performing motion vector estimation within the determined search area.

In operation 1280, a resolution of the candidate motion vector is adjusted and a search area within the reference frame is newly determined at the adjusted resolution based on the adjusted candidate motion vector.

In operation 1300, a motion vector corresponding to a search point having the minimum SAD is determined to be a final motion vector by performing motion vector within the newly determined search area. In this embodiment, the resolution of the newly determined search area is adjusted from level 1 to level 0 and the motion vector corresponding to the search point having the minimum SAD is determined to be the final motion vector by performing motion estimation at level 0 within the newly determined search area.

As described above, in a motion estimation method according to the present invention, by performing motion estimation on a reference frame using a motion vector calculated at a low resolution with reference to an adjacent frame, it is possible to minimize the amount of computation and memory required for motion estimation.

The present invention can be implemented as computer readable codes in computer readable recording media. The computer readable recording media include all kinds of recording media such as ROM, RAM, CD-ROM, magnetic tapes, hard disk, floppy disk, flash memory, optical data storage media, and carrier wave (e.g., transmissions via the Internet). Also, the computer readable recording media is distributed over a computer system connected by network and stored and implemented as computer readable codes.

As described above, by adopting calculation of an absolute difference value according to the present invention, it is possible to reduce the number of adders used for calculation of an absolute difference value and alleviate the load of the apparatus for calculating the absolute difference value, the motion estimation apparatus, and the motion picture encoding apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A motion estimation method encoding motion pictures, the motion estimation method comprising:
calculating an initial motion vector of a predetermined block of a current frame at a low resolution with reference to an adjacent frame of the current frame;
calculating a reference motion vector with reference to the calculated initial motion vector for motion estimation between the current frame and a reference frame; and
adjusting a resolution of the calculated reference motion vector to a high resolution, determining a search area within the reference frame at the high resolution based on the adjusted reference motion vector, and calculating a final motion vector by performing motion estimation within the determined search area.

2. The motion estimation method of claim 1, wherein the reference motion vector is calculated based on the initial motion vector and a scaling coefficient based on a distance between the frames.

3. The motion estimation method of claim 1, wherein a resolution of a horizontal direction of the predetermined block is lower than a resolution of a vertical direction of the predetermined block.

4. The motion estimation method of claim 1, wherein the initial motion vector is calculated using a candidate motion vector that is calculated based on motion vectors of adjacent blocks of the predetermined block.

5. The motion estimation method of claim 4, wherein the candidate motion vector is a median value of the motion vectors of the adjacent blocks.

6. The motion estimation method of claim 4, wherein the motion vectors of the adjacent blocks, used for calculation of the candidate motion vector, are calculated at the low resolution.

7. The motion estimation method of claim 1, wherein the motion estimation method is applied to an IBBP frame according to MPEG 2 standards; and
if the current frame is a P frame, the adjacent frame is a B frame that is adjacent to the P frame and the reference frame is an I frame that is previous to the P frame; and
if the initial motion vector is MV_{L1}, then the reference motion vector is MV_{L1}×3.

8. The motion estimation method of claim 1, wherein the motion estimation method is applied to an IBBP frame according to MPEG 2 standards; and
if the current frame is a B frame that is adjacent to an I frame, then the adjacent frame is the I frame and the reference frame is a P frame; and
if the initial motion vector is MV_{L1}, then the reference motion vector is MV_{L1}×(−2).

9. The motion estimation method of claim 1, wherein the motion estimation method is applied to an IBBP frame according to MPEG 2 standards; and
if the current frame is a B frame that is previous to a P frame, then the adjacent frame is the P frame and the reference frame is an I frame; and
if the initial motion vector is MV_{L1}, then the reference motion vector is MV_{L1}×(−2).

10. The motion estimation method of claim 1, wherein an initial point for final motion estimation is determined by the reference motion vector.

11. The motion estimation method of claim 10, wherein the search area is determined based on the initial point.

12. The motion estimation method of claim 1, wherein the initial motion vector is calculated using hierarchical motion estimation based on a structure of the frames.

13. A computer readable recording medium having recorded thereon a program for a motion estimation method encoding motion pictures, the motion estimation method comprising:
calculating an initial motion vector of a predetermined block of a current frame at a low resolution with reference to an adjacent frame of the current frame;
calculating a reference motion vector with reference to the calculated initial motion vector for motion estimation between the current frame and a reference frame; and
adjusting a resolution of the calculated reference motion vector to a high resolution, determining a search area within the reference frame at the high resolution based on the adjusted reference motion vector, and calculating a final motion vector by performing motion estimation within the determined search area.

14. A motion estimation method encoding motion pictures, the motion estimation method comprising:
calculating an initial motion vector of a predetermined block of a current frame at a low resolution with reference to an adjacent frame of the current frame;
calculating a reference motion vector based on the calculated initial motion vector for motion estimation between the current frame and a reference frame;
determining a first search area in the reference frame based on the reference motion vector and calculating a candidate motion vector by performing motion vector estimation within the determined first search area at a low resolution; and
adjusting a resolution of the calculated candidate motion vector to a high resolution, determining a second search area based on the adjusted candidate motion vector, and calculating a final motion vector by performing motion estimation within the determined second search area at the high resolution.

15. The motion estimation method of claim 14, wherein the reference motion vector is calculated based on the initial motion vector and a scaling coefficient based on a distance between the frames.

16. The motion estimation method of claim 14, wherein the motion estimation method is applied to an IBBP frame according to MPEG 2 standards; and
if the current frame is a P frame, then the adjacent frame is a B frame that is adjacent to the P frame and the reference frame is an I frame that is previous to the P frame; and
if the initial motion vector is MV_{L1}, the reference motion vector is MV_{L1}×3.

17. The motion estimation method of claim 14, wherein the motion estimation method is applied to an IBBP frame according to MPEG 2 standards; and
if the current frame is a B frame that is adjacent to an I frame, then the adjacent frame is the I frame and the reference frame is a P frame; and
if the initial motion vector is MV_{L1}, then the reference motion vector is MV_{L1}×(−2).

18. The motion estimation method of claim 14, wherein the motion estimation method is applied to an IBBP frame according to MPEG 2 standards; and
if the current frame is a B frame that is previous to a P frame, then the adjacent frame is the P frame and the reference frame is an I frame; and
if the initial motion vector is MV_{L1}, then the reference motion vector is MV_{L1}×(−2).

19. A computer readable recording medium having recorded thereon a program for a motion estimation method encoding motion pictures, the motion estimation method comprising:
calculating an initial motion vector of a predetermined block of a current frame at a low resolution with reference to an adjacent frame of the current frame;
calculating a reference motion vector based on the calculated initial motion vector for motion estimation between the current frame and a reference frame;
determining a first search area in the reference frame based on the reference motion vector and calculating a candidate motion vector by performing motion vector estimation within the determined first search area at the low resolution; and
adjusting a resolution of the calculated candidate motion vector to a high resolution, determining a second search area based on the adjusted candidate motion vector, and calculating a final motion vector by performing motion estimation within the determined second search area at the high resolution.

20. A motion estimation method of encoding motion pictures, the motion estimation method comprising:
calculating an initial motion vector of a predetermined block of a current frame at a first resolution with respect to an adjacent frame;
calculating a reference motion vector between the current frame and a reference frame based on the calculated initial motion vector; and
adjusting a resolution of the calculated reference motion vector to a second resolution, determining a search area within the reference frame at the second resolution based on the adjusted reference motion vector, and calculating a final motion vector by performing motion estimation within the determined search area.

21. The motion estimation method of claim 20, wherein the reference motion vector is calculated based on the initial motion vector and a scaling coefficient based on a distance between the frames.

22. The motion estimation method of claim 20, wherein a resolution of a horizontal direction of the predetermined block is lower than a resolution of a vertical direction of the predetermined block.

23. The motion estimation method of claim 20, wherein the initial motion vector is calculated using a candidate motion vector calculated based on motion vectors of adjacent blocks of the predetermined block.

24. The motion estimation method of claim 23, wherein the candidate motion vector is a median value of the motion vectors of the adjacent blocks.

25. The motion estimation method of claim 23, wherein the motion vectors of the adjacent blocks, used for calculation of the candidate motion vector, are calculated at the first resolution.
